(19) United States
(12) Patent Application Publication
(10) Pub. No.: US 2002/0150009 A1
(43) Pub. Date: Oct. 17, 2002

(54) Recording times restricted recording media and recording control method thereof

(75) Inventors: Kenji Tokumitsu, Tokyo (JP); Harukazu Miyamoto, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 09/910,594

(22) Filed: Jul. 20, 2001

(30) Foreign Application Priority Data
Apr. 17, 2001 (JP) 2001-117616

(51) Int. Cl. G11B 7/0045

(52) U.S. Cl. 369/47.14; 369/53.17

(57) ABSTRACT

Possibility for an error due to the disabled access to the data on the recording/reproducing medium having the recording times restriction can be reduced. For this purpose, the information about the recording times restriction is previously stored to the recording/reproduction medium having the recording times restriction and the recording/reproducing apparatus restricts the recording operations not to exceed the recording times restriction using the recording number information of the medium management information such as the defect management table or the like for the update of information. Moreover, when the medium management information is recorded in the multiple points, update of the medium management information exceeding the recording times restriction can be executed through the management to always keep the normal points after update of the medium management information to a plurality of points.

### BACKGROUND OF THE INVENTION

The present invention relates to recording control of the rewritable information recording medium and an information reproducing apparatus and particularly to recording control for an information recording medium with restriction for recording times.

On the occasion of rewritably recording information to an information recording medium with an information recording/reproducing apparatus, an information recording/reproducing apparatus records a user information recording method to an information recording medium and management information such as recording area of such user information to the particular place of the information recording medium, other than information that the user want to record. In response to a request from a host apparatus, a control apparatus for controlling the information recording apparatus makes access to a recording or a reproducing means at the necessary area of the information recording medium in order to record the user information to the information recording medium or reproduce the user information on the information recording medium. The ordinary information recording medium and recording/reproducing apparatus processes the information as the digital information and generally deals, as a unit, the data where the error correction code conforming to the predetermined regulation is added to the digital data of the predetermined amount. As an information recording/reproducing apparatus to process the rewritable information recording medium, there is proposed, for example, a DVD-RAM (Digital Versatile Disc-Random Access Memory) drive. In this apparatus, a DVD-RAM disc is used as the information recording medium. In the DVD-RAM disc, error correction is executed in the block of user data of 32 kB capacity and data management is also executed in unit of this block. When the DVD-RAM drive detects the defective block (data unit region in which recording is impossible because of a defect) at the recording area on the information recording medium during the recording operation, an alternative block is assigned and a defect management table used for management of correspondence between the defective block and alternative block is recorded on the medium. Moreover, it is sometimes executed that a defective block is registered to the defect management table even when the alternative block is not assigned. This defect management table is used, for example, as the Secondary Defect List (SDL) in the ISO IEC (International organization for Standard/ International Electro Technical Commission) 16824 Regulation. SDL is formed of one block and 3837 SDLs can be registered in maximum. In this regulation, SDL is written in four different locations on the medium in order to improve the reliability.

An information recording medium used for rewritable application is widely used as the medium of the type not restricted in the number of recording times. However, if chargeable copy services of information or the like are considered, it is also considered to restrict the number of times of recording. The Official Gazette of the JP-A No. HEI 8-185675 discloses the technique that an area for recording the number of times of recording is provided to the management information recording area of an information recording medium in order to restrict the number of times of recording of user data exceeding the preset number of times. In such disclosed technique, a user is counting only the number of times of recording of the user data and any consideration is not taken into account for the defect of a medium.

In the DVD-RAM drive, a defective block is registered to SDL not only for the recording of user data but also for reproduction of user data if the preset amount of defects is detected. Moreover, a defective block once registered to the SDL is never deleted so long as it is not reformatted. Here, the format means the rewriting of the information recording medium conforming to the predetermined data format. In this case, the recorded user data, SDL and data of alternative block are all deleted in some cases.

In an example of an optical disc, a defect of the information recording medium is generated with the flaws or dusts on the disc surface on the occasion of forming an information recording film with the sputtering method or with adhesion of dusts on the external surface of disc or with a finger-print generated when a user has the disc with a hand. Therefore, the possibility for increase in generation of such defect will become higher when the number of times of use of disc increases.

A medium using magnetic recording method generally assures a large number of times of recording and restriction for the number of times of recording almost does not become a problem. Meanwhile, the information recording medium using the optical recording method is classified into the writing-once optical disc which allows the recording only once and a rewritable optical disc which allows the recording in a plurality of times. Among the writable type optical disc, a phase-changeable type optical disc utilizing the change of phase change of a substance allows only lower number of times of recording.

### BRIEF SUMMARY OF THE INVENTION

In above regulations, SDL is written in four different locations but it may be thought as a means for improving the reliability to realize that the alternative block is assigned for user data even if one or two SDL recording blocks are defective. Basically, since the SDL is updated every time the content of defect management table is changed, resistance for repeated recording (allowable number of times of recording) which is higher than that of the user data recording area is required. For example, in the case where the alternative block is assigned by detecting 10 defective blocks when recording is once executed to the entire part of user data area of DVD-RAM, the SDL recording block is updated for 10 times in maximum. When the 100 defective blocks are detected, the SDL recording block is updated for 100 times in maximum.

A recording medium has the life-time of recordings and when this value is sufficiently large, any problem does not occur in the practical use of medium but if this life-time of recording is rather small value, it can be thought that a certain problem occurs in the practical use. For example, when a medium allows the recording of about 1000 times, it means that about 1000 times of recordings are allowed to the SDL recording blocks. Meanwhile, in the ISO/IEC 16824 regulations, the 3837 registrations to the SDL in maximum are allowed. Therefore, failure of update to SDL blocks is generated before such failure reaches the maximum number of times of registration to SDL, the SDL blocks will no longer be read out in the worst case. Therefore, if these SDL blocks cannot be read out, the user data which is registered to the SDL can no longer be read successfully. As explained above, the number of times of recordings in the SDL will become larger, in the higher possibility, than the number of times of recording of data in the user area. Therefore, the number of times of recordings of SDL reaches the allowable number of times of recordings more quickly than the number of times of recordings of user data in the higher possibility.

The present invention has been proposed to solve the problems explained above and it is therefore an object of the present invention to provide a method to prevent that the access to the target data on the information recording medium is disabled in the information recording medium allowing smaller number of times of recordings. In more detail, it is another object of the present invention to provide a method to provide the number of times of recordings in the SDL which does not exceed the allowable number of times of recordings of the information recording medium.

In view of achieving the objects explained above, the information about the allowable number of times of recordings is previously stored in the reproduction-only area on the information recording medium in the present invention. The reproduction-only area on the recording medium means, for example, the control data zone in the lead-in area provided at the internal circumference side of the DVD-RAM medium as described in the ISO/IEC 16824. This area is the embossed data area (wherein data is expressed with projection and recess). At the time of manufacturing a medium, a disc manufacturer inputs to this area the information to identify the allowable number of times of recordings. Moreover, in the SDL described in the ISO/IEC 16824, the number of times of update (update count) of SDL is defined and the number of times of update of SDL is recorded to SDL blocks in the writable area. The DVD-RAM drive can detect the update count of SDL by reading such recorded value from the medium.

The practical procedures may be understood by referring to the following sequence. When a DVD-RAM medium is loaded to the drive, whether the allowable number of times of recording is set or not is checked by checking the control data zone in the lead-in area of medium. If the allowable number of times of recording is set previously, such allowable number of times of recording is stored on the memory in the DVD-RAM drive and when update of SDL is required, such allowable number of times of recording is compared with the SDL update count read out separately. When the comparison suggests that the SDL update count is under the allowable number of times of recording, the update of SDL is allowed. If the update count of SDL is equal to or larger than the allowable number of times of recording, update of SDL is not allowed and the process is completed as an error. If the allowable number of times of recording is not set previously, the update of SDL is allowed.

With the processes explained above, when the allowable number of times of recording is preset on the medium, update of SDL exceeding the allowable number of times of recording can be prevented and possibility for disabling the read operation of SDL can be lowered.

Moreover, the SDL is written in four different locations in the DVD-RAM. Because of such writing of four different locations, update of SDL can be repeated exceeding the allowable number of times of recording. For example, if the update count of SDL is under the allowable number of times of recording, there is no fear for deterioration of the recording film of SDL and therefore it can be judged that update of SDL cannot be done normally because of deposition of dusts or the like and moreover the update of SDL can be thought as completed normally when the normal update can be checked for one or more points among the writing of four different locations. In addition, when the update count of SDL exceeds the allowable number of times of recording, it is probable to consider that the recording film of SDL is deteriorated. In this case, the reproduced information of SDL is judged severely. Namely, when update is completed normally for two or three points or more, the update of SDL is considered to have completed normally. Thereby, the number of times of updating SDL can be increased. It means that the updates exceeding the allowable number of times of recording are all not considered as errors and it is assumed that the error may be increased rapidly and such errors may also be generated from fluctuation of media. Moreover, a medium manufacturer usually presets the assured number of times as the allowable number of times of recording. Therefore, the allowable number of times of recording has a certain margin and if the number of times of recording has exceeded the allowable number of times of recording, it is possible to have higher expectation to the result of update so long as the judgment has been done within the range of appropriate condition.

### BRIEF DESCRIPTION OF THE SEVERAL VIEWS OF THE DRAWINGS

FIG. 1 is one of the operation flowchart examples during reception of a recording instruction as an embodiment of the present invention.

FIG. 2 is one of the operation flowchart examples during reception of a recording instruction as an embodiment of the present invention.

FIG. 3 is one of the operation flowchart examples during reception of a recording instruction as an embodiment of the present invention.

FIG. 4 is one of the operation flowchart examples during reception of a recording instruction as an embodiment of the present invention.

FIG. 5 is an example of operation flowchart for generation of the medium management information as an embodiment of the present invention.

FIG. 6 is an example of structure of a recording/reproducing apparatus as an embodiment of the present invention.

FIG. 7 is a medium management information example within a recording/reproducing apparatus as an embodiment of the present invention.

FIG. 8 is a structure example of the recording/reproducing apparatus as an embodiment of the present invention.

FIG. 9 is a medium management information example within a recording/reproducing apparatus as an embodiment of the present invention.

FIG. 10 is a defect management table example within a recording/reproducing apparatus as an embodiment of the present invention.

FIG. 11 is one of the operation flowchart examples during reception of a read instruction as an embodiment of the present invention.

### DESCRIPTION OF THE PREFERRED EMBODIMENTS

A preferred embodiment of the present invention will be explained with reference to the accompanying drawings.

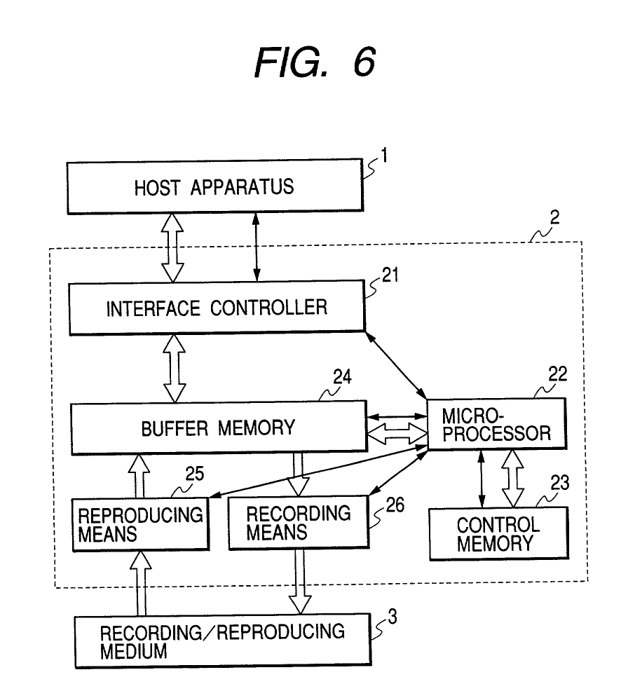

FIG. 6 is a block diagram illustrating an embodiment of the recording/reproducing apparatus of the present invention. In FIG. 6, a recording/reproducing apparatus 2 is provided with an interface controller 21 for controlling exchange of signals with a host apparatus 1 such as a host computer or the like, a buffer memory 24 as a high-speed IC memory for storing recording and reproducing information such as user information or the like, a microprocessor 22 for operating the apparatus in the predetermined sequence to realize the recording/reproducing operation depending on the instruction from the host apparatus 1, a reproducing means 25 for reproducing information from the recording/reproducing medium 3 and then storing such information to the buffer memory 24, a recording means 26 for recording the information from the buffer memory 24 to the recording/reproducing medium 3 and a control memory 23 as the high-speed IC memory for storing the information to specify the control operation with the microprocessor 22. A narrower arrow line in FIG. 6 indicates the flow of control information, while a thick arrow line indicates the flow of data.

FIG. 8 illustrates an example of the recording/reproducing medium 3. The recording/reproducing medium 3 is structured with a reproduction-only area 31 including the control data zone, a defect management table 32 including SDL, an alternative block area 33 and user data area 34. The block in the alternative block area 33 is assigned to the defective block in the user data area 34 and the defective block and alternative block are registered to the SDL within the defect management table 32. In this embodiment, the SDLs in the defect management table 32 are written in two different locations respectively at the internal and external circumferences.

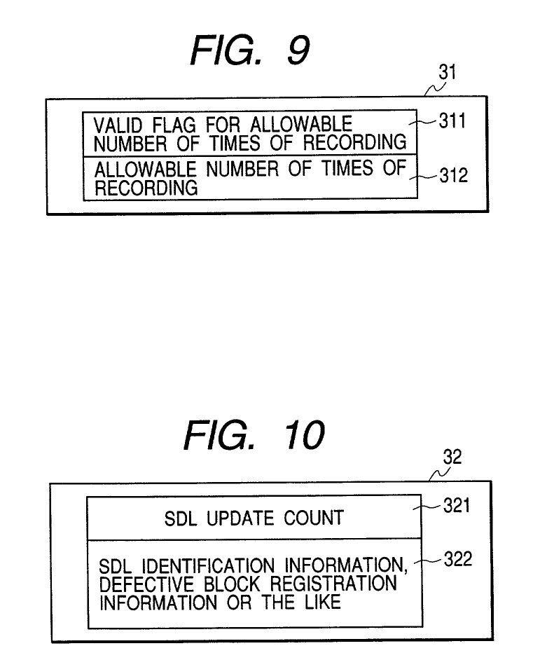

FIG. 9 illustrates the valid flag 311 for the allowable number of times of recording and the allowable number of times of recording 312 within the reproduction-only area 31. The valid flag 311 of the allowable number of times of recording indicates the valid condition when the value of this flag is “1” and the invalid condition when the value of this flag is “0”.

FIG. 10 illustrates an example of the SDL information within the defect management table 32 and is constituted of the SDL update count 321 and defective block registration information or the like 322.

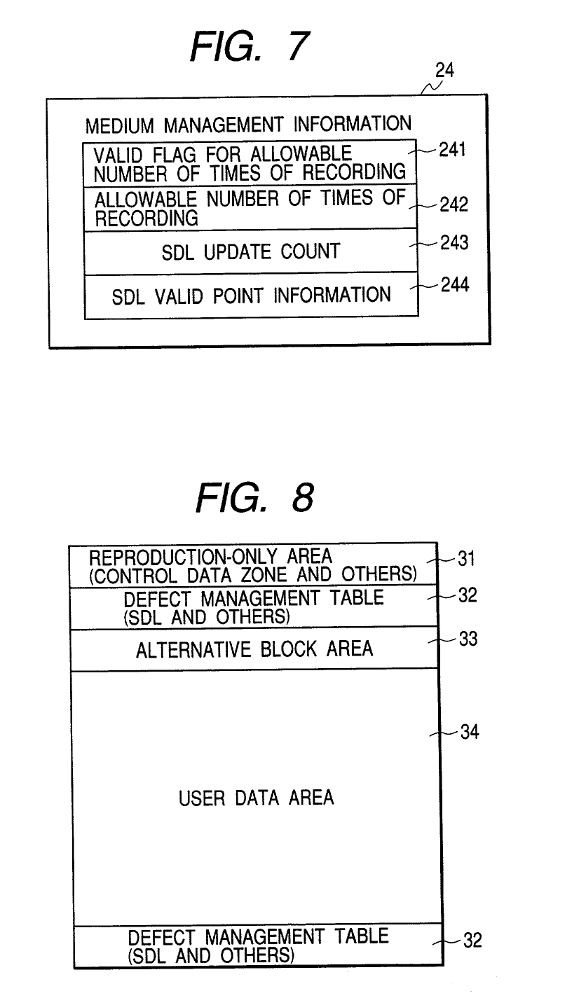

FIG. 7 illustrates a valid flag 241 for allowable number of times of recording to be held within the buffer memory 24, the allowable number of times of recording 242, SDL update count 243 and SDL valid point information 244. The valid flag 241 of allowable number of times of recording and the allowable number of times of recording 242 are generated from the information in the reproduction-only area 31 on the recording/reproducing medium and these indicate the flag suggesting whether the allowable number of times of recording is set or not and the allowable number of times of recording thereof. Moreover, the SDL update count 243 is generated from the SDL information in the defect management table 32 to indicate the number of times of update of SDL. Moreover, the SDL valid point information 244 is generated from the result of reading of the defect management table 32 allocated at the internal and external circumferences to indicate the SDLs recorded normally among a plurality of SDLs.

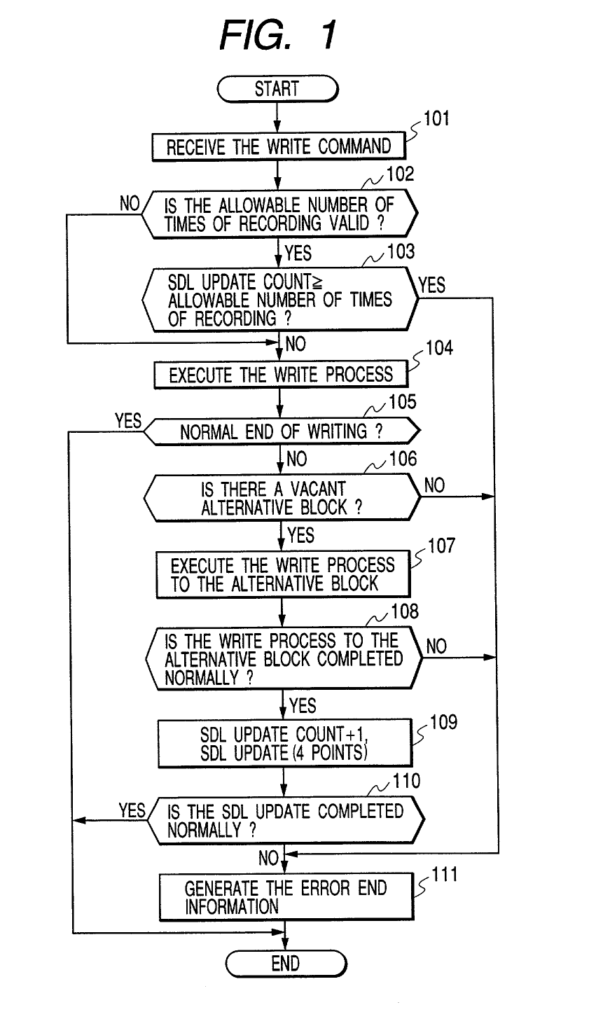

FIG. 1 to FIG. 5 and FIG. 11 illustrate the operation flowchart of an embodiment of the present invention.

A preferred embodiment of the present invention will be explained with reference to FIG. 1 to FIG. 5. Operations of the recording/reproducing apparatus 2 explained below are all placed under the control of the microprocessor 22.

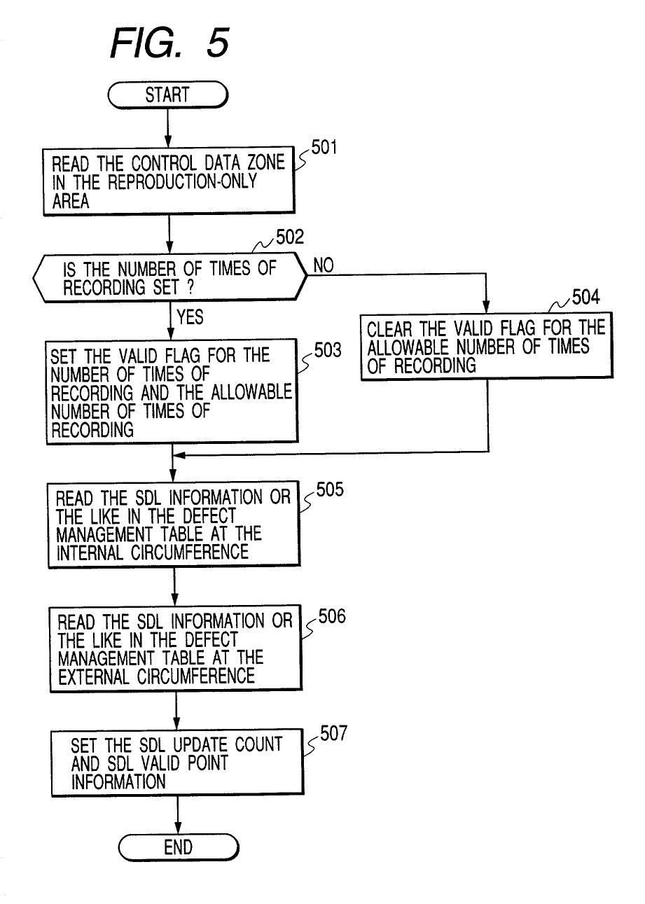

FIG. 5 is the flowchart of the process to read the medium management information of the recording/reproducing medium 3 and then setting this management information into the buffer memory 24 illustrated in FIG. 7. For example, when the recording/reproducing medium 3 is an exchangeable medium, such process is executed when the recording/reproducing medium 3 is loaded to the recording/reproducing apparatus 2. The control data zone of the reproduction-only area 31 is read (step 501) to check whether the valid flag 311 for the allowable number of times of recording is set or not (step 502). When the valid flag for the allowable number of times of recording is set, the valid flag 241 for the allowable number of times of recording and the allowable number of times of recording 242 are set (step 503). If the valid flag 311 for the allowable number of times of recording is not set, the valid flag 241 for the allowable number of times of recording in the buffer memory 24 is cleared (step 504). Thereafter, the defect management table 32 in the internal circumference is read (step 505) and the defect management table 32 at the external circumference is read (step 506) and the SDL update count 243 and SDL valid point information 244 in the buffer memory 24 are set (step 507). Here, the SDL valid point information may be set in the form of flag or in the form of number. Moreover, in this embodiment, it is assumed that the information about the allowable number of times of recording is stored in the reproduction-only area, but the present invention is not limited thereto and such information may be stored in the writable area.

An operation example for the write command (write instruction) issued from the host apparatus 1 under the condition that the medium management information is generated in the buffer memory 24 with the process explained above will be explained with sequential reference to FIG. 1 to FIG. 4.

In FIG. 1, the recording/reproducing apparatus 2 checks, after receiving the WRITE command (step 101), the valid flag 241 for the allowable number of times of recording (step 102). When the valid flag 241 for the allowable number of times of recording is cleared, the process shifts to the step 104. When the valid flag is set, the SDL update count 243 is compared with the allowable number of times of recording 242 (step 103). When the SDL update count 243 is the allowable number of times of recording 242 or larger, the process shifts to the step 111 to complete the process by generating the error end information. When the SDL update count 243 is under the allowable number of times of recording 242, the write process is executed (step 104). After the write process, whether the write process is completed normally or not is checked (step 105). When the process is completed normally, the process is completed. If an error occurs, the alternative block assignment process is executed. First, whether there is a vacant alternative block or not is checked (step 106). If there is no vacant block, the process goes to the step 111 and the process is completed after the error end information is generated. When there is a vacant block, the alternative block write process is executed (step 107) and whether the alternative block write process has been completed normally or not is checked (step 108). If an error occurs, the process goes to the step 111 and is completed by generating the error end information. When the alternative block write process is completed normally, one (1) is added to the SDL update count, the SDL in the defect management table 32 at the internal and external circumferences are updated at the four points (step 109) and whether the SDL update is completed normally or not is checked (step 110). When the SDL update is completed normally, the process is completed. If an error occurs, the error information is generated (step 111) to complete the process. In the determination whether the SDL update is completed normally or not, it is enough when the normal update is executed at the N or more points (1≦N≦4). In above explanation, the check to detect the write process has been executed normally is determined in such a manner that when the relevant data block is once written and it is then read without any error or in the condition that the data block can be read through the correction, the recording has been determined as the normal recording and if not, the recording has been determined as defective or erroneous recording. Moreover, when the relevant data block is once written and is then read, the content to be recorded being stored in the buffer memory 24 is compared with the content read out. When these contents are matched with each other, the recording is determined as the normal recording and if these are not matched, the recording is determined as defective or erroneous recording.

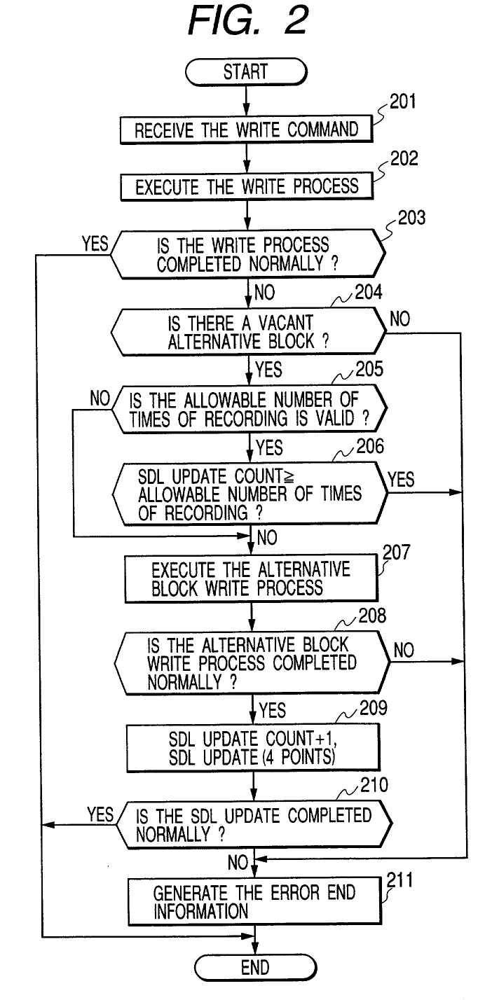

In this operation example, the SDL is not updated when there is no vacant alternative-block in the determination of the step 106 or when the alternative block write in the step 108 is erroneous, but even in these cases, it is also allowable that the defective block is registered to the SDL. In addition, in this operation example, any write operation is not executed when the SDL update count is equal to or larger than the allowable number of times of recording in the determination of step 103, but such write operation is also executable. The embodiment in such a case will be explained with reference to the flowchart of FIG. 2.

In FIG. 2, the recording/reproducing apparatus 2 receives the WRITE command from the host apparatus 1 (step 201) and then executes the write process (step 202) and then checks whether this process has been executed normally or not (step 203). When the process is completely normally, this process is completed and if an error occurs, the alternative block assignment process is executed. First, whether there is a vacant alternative block or not is checked (step 204). If there is no vacant block, the process goes to the step 211 and the process is completed with generation of the error end information. When there is a vacant alternative block, the valid flag 241 for the allowable number of times of recording is checked (step 205). When the valid flag 241 for the allowable number of times of recording is cleared, the process goes to the step 207. When the valid flag 241 is set, the SDL update count 243 is compared with the allowable number of times of recording 242 (step 206). When the SDL update count 243 is the allowable number of times of recording 242 or larger, the process goes to the step 211 and the process is completed with generation of the error end information. When the SDL update count 243 is under the allowable number of times of recording 242, the alternative block write process is executed (step 207) and whether the alternative block write process is completed normally or not is checked (step 208). When an error occurs, the process goes to the step 211 and the process is completed with generation of the error end information. When the process is completed normally, one (1) is added to the SDL update count and the SDL is updated in the four points in the defect management table 32 at the internal and external circumferences (step 209) and checks whether the SDL update count has been completed normally or not (step 210). When the process is completed normally, the process is completed but if an error occurs, the process is completed with generation of the error end information (step 211). For the determination whether the SDL update has been completed normally or not, it is considered enough when the SDL is updated normally at the points N (1≦N≦4) points or more.

In above operation example, when the valid flag 241 for the allowable number of times of recording is set and the SDL update count 243 is the allowable number of times of recording 242 or larger, the write process is controlled or the alternative block assignment process is controlled. However, even if the SDL update count 243 is larger than the allowable number of times of recording, it does not become an error immediately, and it is only assumed that an error increases rapidly. In some cases, such error is caused by fluctuation of a medium and a medium manufacturer usually sets previously the assured number of times as the allowable number of times of recording. Therefore, if the SDL update count has exceeded the allowable number of times of recording, such value has a certain margin for the allowable number of times of recording. Operation example for executing the SDL update exceeding the allowable number of times of recording will be explained hereunder.

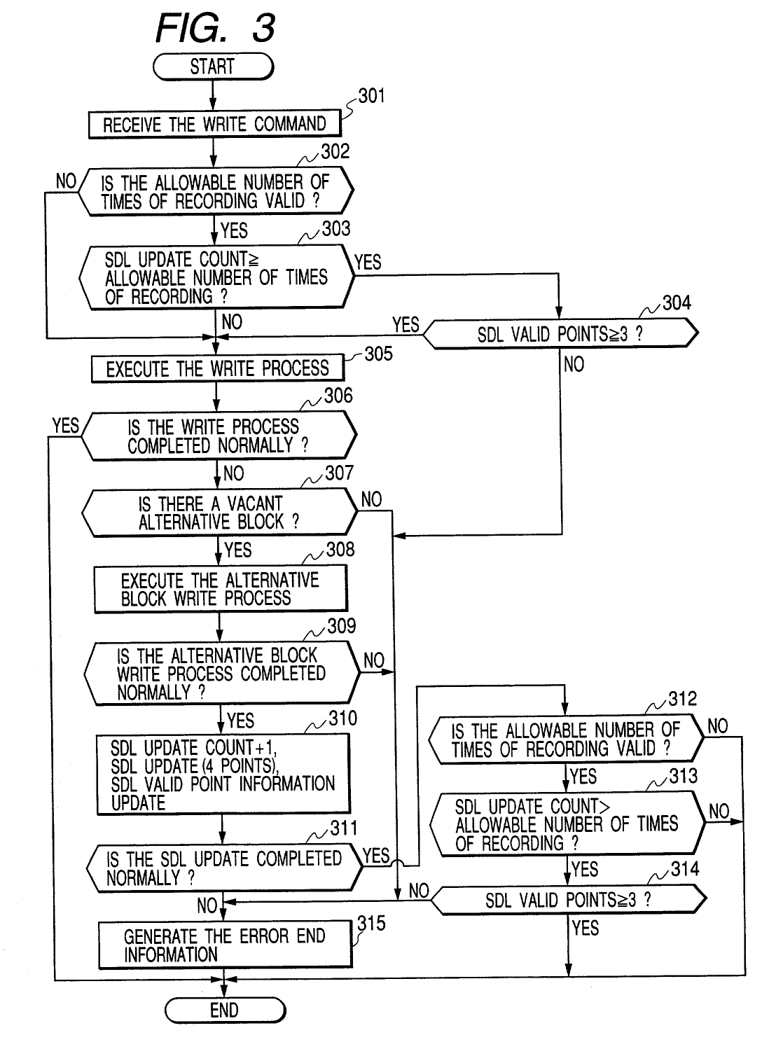

In FIG. 3, the recording/reproducing apparatus 2 receives the WRITE command from the host apparatus (step 301) and then checks the valid flag 241 for allowable number of times of recording (step 302). When the valid flag 241 for allowable number of times of recording is cleared, the process goes to the step 305. When the valid flag 241 is set, the SDL update count 243 is compared with the allowable number of times of recording 242 (step 303). When the SDL update count 243 is under the allowable number of times of recording 242, the process goes to the step 305 to execute the write process. When the SDL update count 243 is the allowable number of times of recording 242 or larger, the SDL valid point information 244 is checked (step 304). When the SDL valid point number is under 3, the process goes to the step 315 and the process is completed with generation of the error end information. When the SDL valid point number is 3 or larger, the write process is executed (step 305). After the write process, whether the write process has been completed normally or not is checked (step 306). When the write process is completed normally, the process is completed. If an error occurs, the alternative block assignment process is executed. First, whether there is a vacant alternative block or not is checked (step 307). If there is no vacant block, the process goes to the step 315 and the process is completed with generation of the error end information. When there is a vacant alternative block, the alternative block write process is executed (step 308) and whether the alternative block write process is completed normally or not is checked (step 309). If an error occurs, the process shifts to the step 315 and the process is completed with generation of the error end information. When the alternative block write process is completed normally, one (1) is added to the SDL update count, the SDL is updated at four points in the defect management table at the internal and external circumferences, the SDL valid point information 244 is updated based on the result of update (step 310) and whether the SDL update is completed normally or is checked (step 311). If an error occurs, the process is completed with generation of the error end information (step 315). When update is completed normally, the valid flag 241 for allowable number of times of recording is checked (step 312). When the valid flag 241 for allowable number of times of recording is cleared, the process is completed and when the valid flag 241 is set, the SDL update count 243 is compared with the allowable number of times of recording 242 (step 313). When the SDL update count 243 is the allowable number of times of recording 242 or less, the process is completed. When the SDL update count 243 is larger than the allowable number of times of recording 242, the SDL valid point information 242 is checked (step 314). When the SDL valid point information is 3 or larger, the process is completed and when the SDL valid point information is under 3, the process goes to the step 315 and the process is completed with generation of the error end information. For the determination whether the SDL update has been completed normally or not in the step 311, the update is considered normal when the update is completed normally at the N (1≦N≦3) points or more. In the steps 304 and 314, the SDL valid point number is determined at the three points or more, but such determination may be executed at the four points or more. When the SDL valid point number is defined as M, it is enough when the relationship of M>N is maintained. This determination is based on the concept that when a plurality of SDLs are held, such SDLs cannot be read simultaneously and possibility for disabled access to the medium can be reduced sufficiently.

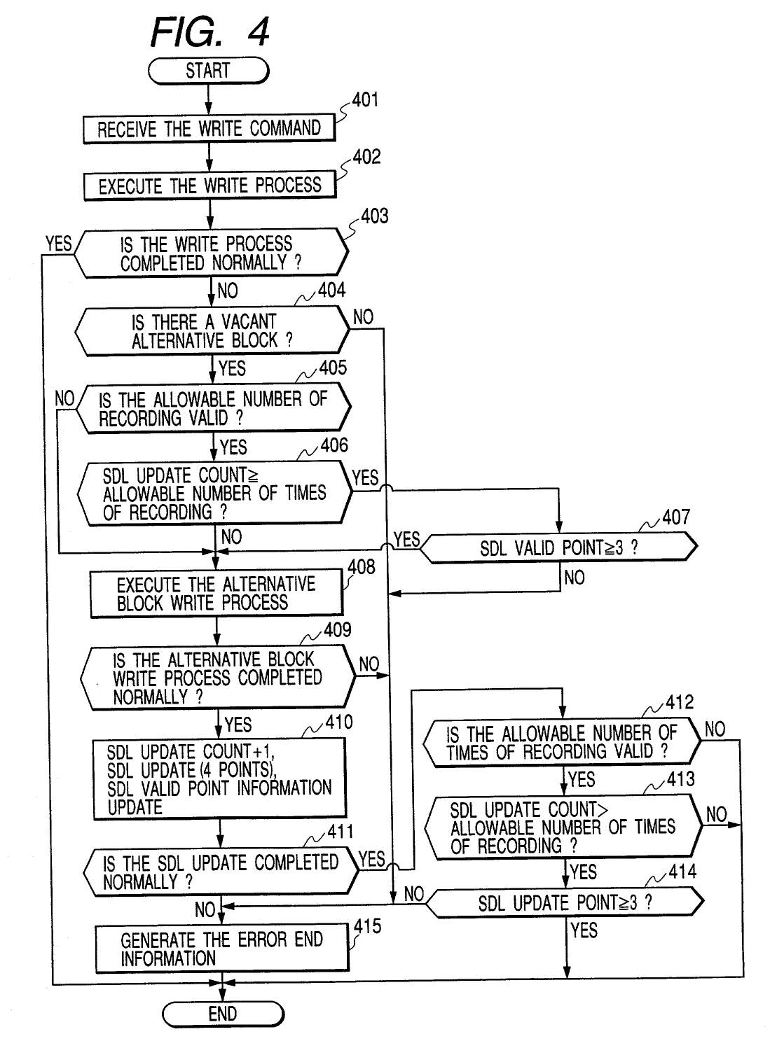

In this operation example, the SDL is not updated when there is no vacant alternative-block in the step 307 or when the alternative block write operation is completed erroneously in the step 309. However, even in these cases, it is also allowed that the defective blocks are registered to the SDL. Moreover, in this operation example, the write process is not executed when the SDL valid point number is under 3 in the step 304, but it is also possible to execute the write operation. The flowchart of such write operation will be explained with reference to FIG. 4.

In FIG. 4, the recording/reproducing apparatus 2 receives the WRITE command from the host apparatus 1 (step 401) and then executes the write process (step 402). Here, whether the write operation is completed normally or not is checked (step 403). When completion is normal, the process is completed here. If an error occurs, the alternative block assignment process is executed. First, whether there is a vacant alternative block or not is checked (step 404). If there is no vacant alternative block, the process goes to the step 415 and the process is completed with generation of the error end information. When there is a vacant alternative block, the valid flag 241 for allowable number of times of recording is checked (step 405). Here, when the valid flag 241 for allowable number of times of recording is cleared, the process goes to the step 408. When the valid flag 241 is set, the SDL update count 243 is compared with the allowable number of times of recording 242 (step 406). When the SDL update count 243 is under the allowable number of times of recording 242, the process goes to the step 408 to execute the alternative block write process. When the SDL update count 243 is the allowable number of times of recording 242 or larger, the SDL valid point information 244 is checked (step 407). When the SDL valid point number is under 3, the process goes to the step 415 and the process is completed with generation of the error end information and when the SDL valid point number is 3 or larger, the alternative block write process is executed (step 408) and whether the alternative block write process has been completed normally or not is checked (step 409). If an error occurs, the process goes to the step 415 and the process is completed with generation of the error end information. When the write process is completed normally, one (1) is added to the SDL update count, the SDL is updated at four points in the defect management table 32 at the internal and external circumferences, the SDL valid point information 244 is updated based on the update result (step 410) and whether the SDL update has been completed normally or not is checked (step 411). If an error occurs here, error information is generated (step 415) to complete the process. When completion is normal, the valid flag 241 for allowable number of times of recording is checked (step 412). When the valid flag 241 for allowable number of times of recording is cleared, the process is completed and when the valid flag 241 for allowable number of times of recording is set, the SDL update count 243 is compared with the allowable number of times of recording 242 (step 413). When the SDL update count 243 is the allowable number of times of recording 242 or less, the process is completed and when the SDL update count 243 is larger than the allowable number of times of recording 242, the SDL valid point information 244 is checked (step 414). When the SDL valid point number is 3 or larger, the process is completed and when the SDL valid point number is under 3, the process goes to the step 415 and the process is completed with generation of the error end information. For the determination whether the SDL update is completed normally or not in the step 411, the completion is considered normal when the update process is completed normally at N (1≦N≦3) points or more. Determination of the SDL valid point number in the steps 407 and 414 is executed at the three points or more, but such determination can also be made at the two points or more or four points or more. When the SDL valid point number is defined as M, it is enough when the relationship of M>N is maintained. This determination is based on the concept that when a plurality of normal SDLs are held, such SDLs cannot be read simultaneously and possibility for disabled access to the medium can be reduced sufficiently.

In this operation example, the SDL is not updated when there is no vacant alternative block at the determination in the step 404 and an error occurs in the alternative block write at the determination in the step 409. However, in these cases, it is also possible to register the defective block to the SDL.

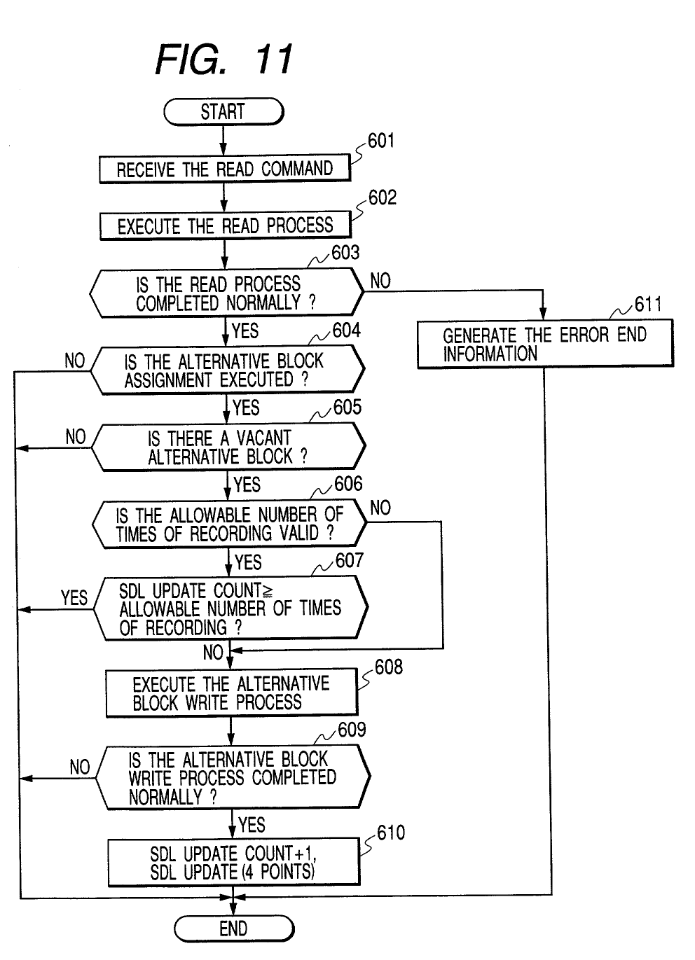

An operation example for the READ command (readout instruction) from the host apparatus 1 will be explained with reference to FIG. 11.

The recording/reproducing apparatus 2 receives the READ command (step 601) from the host apparatus 1 and then executes the read process (step 602) and then check whether the read operation is completed normally or not (step 603). If an error occurs, the process goes to the step 611 and the process is completed with generation of the error end information. When the read operation is completed normally, whether the alternative block assignment should be performed or not is checked (step 604). This alternative block assignment in the read operation is executed when the retry operation is necessary for normal read operation or when read operation can be executed normally but the number of error bytes which requires ECC error correction is large. If the alternative block assignment is not required, the process is completed, but when assignment is required, whether there is a vacant alternative block or not is checked (step 605). If the there is no vacant block, the process is completed here. When there is a vacant block, the valid flag 241 for allowable number of times of recording is checked (step 606). When the valid flag 241 for allowable number of times of recording is cleared, the process goes to the step 608. When the valid flag 241 is set, the SDL update count 243 is compared with the allowable number of times of recording 242 (step 607). When the SDL update count 243 is the allowable number of times of recording 242 or larger, the process is completed. When the SDL update count 243 is under the allowable number of times of recording 242, the process goes to the step 608 to execute the alternative block write process. Here, whether the alternative block write process is completed normally or not is checked (step 609). When the completion is normal, one (1) is added to the SDL update count and the SDL is updated at the four points in the defect management table 32 at the internal and external circumferences (step 610) to complete the process.

In this operation example, the process is completed without generation of the error end information when there is no vacant alternative block at the determination in the step 605, or when the SDL update count 243 is the allowable number of times of recording 242 or larger at the determination in the step 607 or when an error occurs at the determination in the step 609, but the process may be completed with generation of error end information. Moreover, the step for determining the normal completion or not is not provided after the process in the step 610, but the step of this determination may also be provided.

As explained above, the present invention can control the recording exceeding the limitation on the write process to the block having the recording number information in the recording/re-producing medium which is restricted in the number of times of recording. Thereby, it is now possible to restrict the number of times of recording the management information or the like such as the defect management table or the like. As a result, since deterioration in reliability of management information can be lowered, possibility for disabled access to the data on the medium due to the management information read error can also be reduced. Moreover, in such a case that the management information is recorded in multiple recording method, the reliability can be maintained by controlling the recording operation to always maintain a plurality of normal management information pieces even when such operation is executed exceeding the restricted number of times of recording.

The present invention can control the recording times exceeding the restriction on the write operation to the block having the recording number information in the recording/reproducing medium having the recording times restriction and therefore assures reliability of management information and reduce the possibility for disabled access to the data on the medium with the management information read error. Moreover, in such a case where the management information is recorded in the multiple recording method, even if the recordings are executed exceeding the recording times restriction, higher reliability of management information can be maintained and possibility for disabled access to the data on the medium due to the management information read error can further be reduced.

What is claimed is:

1. An information recording medium which includes a user data area and a medium management information area and allows update of information, comprising:
an alternative area for the area including a defect on said information recording medium detected when information is recorded or reproduced; and
a management area for management of correspondence between said area including defect and said alternative area,
wherein the information for identifying the allowable number of times of recording of information is previously recorded on the recording medium.

2. An information recording/reproducing medium as claimed in claim 1, wherein said user data, medium management information, alternative area and management area conform to the DVD-RAM format and said management area is the secondary defect list (SDL).

3. An information recording control method for conducting recording and reproduction of information to an information recording medium having a user data area, an alternative area for the defective area and a medium management information area to execute the update of information, wherein information for identifying said allowable number of times of recording of information is previously recorded to said information recording medium, if a defect on said information recording medium is detected during recording or reproduction of information, the information indicating the alternative area to said area including the defect is recorded to said medium management information area, and when the recordings to at least said medium management information area exceed the allowable number of times of recording based on said information for identifying the allowable number of times of recording, the recording is controlled.

4. An information recording control method as claimed in claim 3, wherein the information update count is recorded to said medium management information area and the update of information to said medium management information area is controlled by comparing said update count and said allowable number of times of recording.

5. An information recording control method as claimed in claim 4, wherein the recording to said medium management information area is continued when said medium management information area is recorded in multiple on the two or more areas and recording is completed normally to the two or more predetermined number of areas among said multiple recording areas.

6. An information recording control method as claimed in claim 4, wherein said update count is compared with said allowable number of times of recording when said allowable number of times of recording is set, when said update count is under said allowable number of times of recording, update of recording times to said medium management information area is allowed, and when said update count is said allowable number of times of recording or larger, update of recording times to said medium management information area is not allowed for the erroneous completion of process, and if said allowable number of times of recording is not yet set, update of recording times to said medium management information area is also allowed.

7. An information recording control method as claimed in claim 3, wherein said medium management area is the secondary defect list (SDL) conforming to the DVD-RAM format.

8. An information recording control method for conducting recording and reproduction of information to an information recording medium which allows update of information, comprising the steps of:
recording information indicating an alternative area for the area including a defect to the medium management information area when said defect on said information recording medium is detected at the time of recording or reproducing information, and
controlling the recording and reproduction of information depending on the number of times of recording of information indicating said alternative area to said medium management information area.

9. An information recording control method as claimed in claim 8, wherein the allowable number of times of information is previously recorded to said information recording medium, and said method includes a step for controlling the recording and reproduction of information by comparing said allowable number of times of recording to the number of times of recording to said medium management information area.

10. An information recording control method as claimed in claim 9, wherein the information indicating the alternative area is recorded to said medium management information area in multiple to a plurality of areas, and said method also includes the step for continuing the recording and reproduction of information when the recorded information is read out normally from two or more predetermined number of areas among a plurality of said medium management information areas.

11. An information recording control method as claimed in claim 10, wherein the recording and reproduction of information are continued when the number of normal areas in said medium management information area is the predetermined number or larger even if the number of times of recording to said medium management information area is said allowable number of times of recording or larger.

12. An information recording control method as claimed in claim 11, wherein said medium management information area is the secondary defect list (SDL) conforming to the DVD-RAM format.
